(19) United States
(12) Patent Application Publication
(10) Pub. No.: US 2026/0323453 A1
(43) Pub. Date: Oct. 15, 2026

(54) METHOD AND WIRELESS COMMUNICATION SYSTEM FOR ENERGY EFFICIENT COVERAGE ENHANCEMENT

(71) Applicant: Continental Automotive Technologies GmbH, Hannover (DE)

(72) Inventors: Shravan Kumar Kalyankar, Singapore (SG); Rikin Shah, Langen (DE); David Gonzalez Gonzalez, Egelsbach (DE); Reuben George Stephen, Singapore (SG); Hojin Kim, Regensburg (DE)

(73) Assignee: Continental Automotive Technologies GmbH, Hannover (DE)

(21) Appl. No.: 19/117,150

(22) PCT Filed: Sep. 25, 2023
(86) PCT No.: PCT/EP2023/076323

§ 371 Date: Mar. 31, 2025

(30) Foreign Application Priority Data
Sep. 29, 2022 (DE) 10 2022 210 364.5

(51) Int. Cl. H04W 36/16; H04W 36/14; H04W 36/30; H04W 74/0833; H04W 84/06

(52) U.S. Cl. CPC H04W 36/165; H04W 36/14; H04W 36/30; H04W 74/0833; H04W 84/06

(57) ABSTRACT

Method for Energy Efficient Coverage Enhancement comprising the steps that when the user equipment is in idle mode, user equipment decides whether to switch to alternative network or not based on overall network congestion, whereby this information is indicated by the network, by reaching the maximum of random access procedure failure for a Coverage Enhancement level (k), and cell selection on alternative networks is proceeded with, the coverage of the cell is verified and in case the coverage of the cell is sufficient, then the user equipment is switched to alternative network and performs random access procedure, in case the coverage of the cell is insufficient, the user equipment stays in the same network and upgrades to Coverage Enhancement level (k+1) from the previous level (k) for subsequent random access procedure.

### CROSS-REFERENCE TO RELATED APPLICATIONS

The present application is a National Stage Application under 35 U.S.C. § 371 of International Patent Application No. PCT/EP2023/076323 filed on Sep. 25, 2023, and claims priority from German Patent Application No. 10 2022 210 364.5 filed on Sep. 29, 2022, in the German Patent and Trademark Office, the disclosures of which are herein incorporated by reference in their entireties.

### TECHNICAL FIELD

The present disclosure relates to Energy Efficient Coverage Enhancement in wireless communications systems.

### BACKGROUND

The Third Generation Partnership Project (3GPP) has standardized Coverage Enhancement (CE) for Internet-of-Things (IoT) to connect devices in challenging radio conditions with cellular networks. CE is based on the principle of prolonged transmission time that exploits the fact that many IoT applications have relaxed requirements on data rate and latency, and the coverage can be significantly boosted by repeating transmissions for such applications. However, CE consumes a lot of radio resources and should be implemented carefully for different applications.

Evolution of wireless communication technologies toward the fifth-generation (5G) enables everything to be connected through the internet. For example, lots of information related to human activities have been recorded, monitored through various types of IoT applications (e.g., health monitoring, smart home, intelligent transportation, industrial automation), and exchanged through cellular networks. However, unfortunately, conventional cellular networks have not been designed to accommodate such diverse IoT applications. Accordingly, enormous efforts have been made to support the emerging IoT scenario in cellular networks, which is referred to massive machine-type communications (mMTC) or massive IoT (mIoT) as one of the main use cases of 5G.

In cellular networks, an extremely large number of IoT devices are expected to be deployed, where the number of connected devices will reach 500 billion by 2030. Each IoT device sporadically generates small-sized packets to report sensing information to the IoT server through a base station (BS/gNB). In particular, an IoT device stays out-of-connection with the BS to reduce energy consumption due to the sporadic packet generation. This implies that each of IoT devices should perform random access (RA) procedure to establish a connection with the BS, whenever transmitting data packets to the IoT server. The RA procedure adopted in the existing cellular systems such as LTE/LTE-A/5G consists of four-steps of handshaking procedure. Due to the densely deployed IoT devices in cellular IoT networks, simultaneous RA attempts at a certain RA slot (or, equivalently, physical RA channel (PRACH)) may cause collision problem. Collision problem highly causes the poor access performance (i.e., RA failure) at the device side. To be specific, IoT devices may spend considerable time to access the networks and thus the networks cannot guarantee acceptable end-to-end delay according to their access priority.

In cellular systems, a connection between each IoT device and the BS is pre-required for data communications. For establishing a connection, a device should proceed 4-steps of RA procedure. It is summarized that the overall descriptions on the conventional RA procedure in cellular networks (e.g., LTE/LTE-A/5G) is as follows
Step1. Preamble transmissions: Each IoT device randomly selects a single RA preamble among a set of available RA preambles, and transmits it on the PRACH.
Step2. Random access responses: The BS detects which preambles are active. In response to the detected preambles, the BS transmits random access response (RAR) messages, each of which consists of an RA preamble identifier (RAPID), a timing alignment (TA), an uplink grant (UG), and a temporary identifier. Each IoT device which transmitted a preamble at the first step waits for the RAR message containing the same RAPID. If there exists the corresponding RAR message, each device utilizes information within the message for the subsequent step (i.e., Step3).
Step3. Scheduled transmissions: Each IoT device transmits its scheduled message (e.g., connection request message) on the assigned uplink resource on physical uplink shared channel (PUSCH), indicated by the UG value contained in the RAR message received in the second step. In order to determine whether the resource collision on the used uplink resource occurs or not, each IoT device starts a contention resolution (CR) timer once the Step3 message is transmitted.
Step4. Acknowledgement: The BS echoes the identifiers of the IoT devices, whose transmitted scheduled messages are successfully decoded without any resource collisions. If each IoT device receives the correct acknowledgement (ACK) message before the CR timer expires, then it regards the RA attempt as a success. Otherwise, it regards the RA attempt as a failure and reattempts the RA procedure at the next-available RA slot after performing a back-off.

US2022131602 A1 discloses a method, network node and wireless device for reliable link performance for cellular Internet of things (IoT) and New Radio (NR) in non-terrestrial networks. In some embodiments, a network node configured to operate in a cellular non-terrestrial network is provided. The network node includes processing circuitry configured to provide an indication of transmission property information associated with a reconfiguration of precoding weights where the indication of transmission property information provides information associated with decoding a physical downlink shared channel or physical downlink control channel.

WO 2021204079 A1 describes methods, systems, and devices for wireless communications in which a block error rate (BLER) in non-terrestrial network (NTN) communications may be reduced through coverage enhancement techniques. Coverage enhancement techniques may include slot bundling for physical downlink control channel (PDCCH) communications, in which repetitions of a PDCCH may occupy multiple time-frequency locations spanning multiple slots. Such slots can be consecutive or non-consecutive, and in some cases multiple repetitions of the PDCCH may be provided within the same slot. The pattern of the time-frequency locations of repetitions may be periodic or non-periodic. Further, the repetitions can be exact copies, or different redundancy versions of the same encoded DCI. Additionally, repetitions of uplink or downlink shared channel communications, uplink or downlink control channel communication, broadcast channel communications, or any combinations thereof, may be provided.

CN 113644950 discloses a non-terrestrial network (NTN) communication method and a non-terrestrial network communication device, which are used for solving the problem that a cell covered by a terrestrial base station and a cell covered by a satellite can't be distinguished when UE (User Equipment) executes a communication service sensitive to time delay, and the cell covered by the satellite can be possibly selected. The method comprises the following steps: a first network device determines cell type information of a cell covered by a second network device, the cell type information being used for indicating that the cell is a ground network communication cell or a non-terrestrial network communication cell. And the first network equipment sends the cell type information to the third network equipment. In the embodiment of the invention, when the interface connection is established between the first network equipment and the third network equipment under the NTN scene, the related NTN indication (namely the cell type information of the second network equipment) is carried, so that the third network equipment can further know the capability and characteristics of the first network equipment.

US2021194572 A1 provides UE parameter determination method and apparatus, storage medium and base station. The method includes: determining a minimum round trip time between each UE in a cell and a satellite; determining frame information of a network-side uplink radio frame based on the minimum round trip time and frame information of a network-side downlink radio frame, where the minimum round trip time is a timing difference by which the network-side uplink radio frame lags behind the network-side downlink radio frame; and determining a UE parameter of each UE based on the network-side uplink radio frame and the network-side downlink radio frame, where UE parameter includes at least one of TA or K2. By the method, an NTN network can be supported on the premise that modification of software and hardware of a terrestrial network UE is minimized, thereby effectively avoiding extra maintenance cost of software and hardware.

WO 2022082771 A1 describes beam management for non-terrestrial networks (NTN). One example aspect is A baseband processor, comprising: a memory interface; and processing communicatively coupled to the memory and transceiver interface and, while connected to a base station (BS) within a cell of a non-terrestrial network (NTN) and, where the cell comprises a plurality of bandwidth parts (BWPs) associated with a plurality of beams, configured to perform operations comprising: receiving a signaling from the base station (BS) comprising a channel state indicator reference signal (CSI-RS) configuration associated with a first BWP of the plurality of BWPs, where the CSI-RS configuration comprises a beam measurement configuration for the plurality of beams, switching from a second BWP of the plurality of BWPs to the first BWP according to the CSI-RS configuration and measure one or more of the plurality of beams according to the beam measurement configuration; and generating a measurement report that includes a layer 1 reference signal received power (L1-RSRP) measurement from the measured one or more of the plurality of beams.

US2021306927 A1 describes a method for operating an infrastructure equipment forming part of a wireless communications network. The wireless communications network comprises a base station and a non-terrestrial network part, the non-terrestrial network part transmitting one or more spot beams to provide a wireless access interface for transmitting signals to and receiving signals representing data from a communications device within a coverage region of a cell or one of the spot beams, the spot beam forming a cell. The method comprises transmitting, to the communications device, an indication of a first condition to be met before the communications device should transmit assistance information to the infrastructure equipment, receiving the assistance information from the communications device upon the first condition being met, determining, based on the assistance information, that a cell change of the communications device should be initiated, and initiating the cell change of the communications device.

WO 2022082662 A1 discussed techniques may better ensure proper timing and synchronization of transmissions within a wireless communications network that includes a terrestrial network and a non-terrestrial network (NTN). A user equipment (UE) may maintain (e.g., determine and update on an ongoing basis) a timing advance (TA) value that the UE may apply to uplink (UL) transmissions to account for propagation delays, including changes in propagation delays, between the UE, NTN, and terrestrial network. TA maintenance may be based on network broadcasts, random access channel (RACH) procedures, control messages, timing drift rates (e.g., of the UE or NTN satellite), beam switching, and more.

WO 2022082744 A1 discloses user equipment (UE) associated with a non-terrestrial network (NTN). The UE comprises a processor configured to determine a first time offset, based on processing a timing offset indication signal comprising the first time offset or an associated parameter, received from a base station. In some embodiments, the first time offset is indicative of a time delay in downlink (DL) to uplink (UL) interaction between the UE and the base station. The processor is further configured to determine a second time offset, based on processing a subsequent timing offset indication signal comprising the second time offset or an associated parameter, received from the base station at a subsequent time instance. In some embodiments, the processor is further configured to update the first time offset with the second time offset.

WO 2021156749 A1 describes a method performed by a wireless device includes obtaining a remaining service time (Tservice) associated with a first satellite or first spot beam. Based on the remaining service time, the wireless device determines whether to initiate a connection with the first satellite or first spot beam.

Massive IoT is a technology that supports massive numbers of devices, long device battery life, low device complexity to ensure low cost, and coverage enhancements to reach devices in challenging locations (forest, basement, etc.).

LPWAN is a wireless technology designed for long range, low bit rate, and battery operated IoT devices (especially Massive IoT devices). NB-IoT is a Cellular IoT technology introduced by 3GPP to fulfill the LPWAN requirement.

Power saving mechanisms are designed to improve the UE energy efficiency. The UE battery life decides the UE life (NB-IoT) and the expected IoT device lifetime is more than 10 years.

3gpp had been introduced power saving mechanism (UE) (DRx, eDRx, RAI, WuS) to improve UE energy efficiency.

Massive IoT devices that stay in poor coverage conditions for a longer duration will suffer from higher energy consumption because of higher Coverage Enhancement (CE) levels resulting in lower battery life.

The main of goal of this application is to give a solution to all the opportunities to maintain communication at a lower Coverage Enhancement (CE) level for a Massive IoT device (UE).

### BRIEF SUMMARY

The described problem is solved by the embodiments of this application.

According to certain embodiment the method for Energy Efficient Coverage Enhancement (CE) is characterized by a user equipment (UE) device connected to a wireless communication network, wherein the user equipment (UE) decides to upgrade to higher level of Coverage Enhancement (CE) or to switch the network in case of reaching maximum Random access (RA) procedure failure.

A particular embodiment is characterized by a method for Energy Efficient Coverage Enhancement (CE), comprising the steps that user equipment (UE) is in idle mode, user equipment (UE) decides whether to switch to alternative network or not based on overall network congestion, whereby this information is indicated by the network, by reaching the maximum of random access (RA) procedure failure for a Coverage Enhancement (CE) level (k), cell selection on alternative networks is proceed, the coverage of the cell is verified and in case of the coverage of the cell is sufficient, then the user equipment (UE) is switched to alternative network and performs random access (RA) procedure, in case of the coverage of the cell is insufficient, then the user equipment (UE) stays in the same network and upgrades to Coverage Enhancement (CE) level (k) to the level (k+1) for random access (RA) procedure.

According to certain embodiment the method for Energy Efficient Coverage Enhancement (CE), comprising the steps that user equipment (UE) is in connected mode, user equipment (UE) decides whether to switch to alternative network or not based on overall network congestion, whereby this decision information is determined by reaching the maximum of random access (RA) procedure failure for a Coverage Enhancement (CE) level (k), in case the maximum of random access (RA) procedure failure for a Coverage Enhancement (CE) level (k) is reached, a check if the user equipment (UE) triggered handover to alternative network should be proceeded is done, if the result of the check is positive, then the handover to alternative network is proceeded, if the result of the check is negative, then the user equipment (UE) stays in the same network and upgrades to Coverage Enhancement (CE) level (k) to the level (k+1) for random access (RA) procedure.

A particular embodiment is characterized by the method for Energy Efficient Coverage Enhancement (CE) according to claims 1 to 3, wherein in case of reaching maximum Random access (RA) procedure failure the network is switched from terrestrial network to non terrestrial network (TN to NTN) or from non terrestrial network to terrestrial network (NTN to TN).

A certain embodiment is characterized by wherein the user equipment (UE) is a user equipment for Narrowband Internet of things UE (NB-IoT), which considers utilizing the non terrestrial network to terrestrial network (NTN) before upgrading to the higher-level Coverage Enhancement (CE, CE 1, CE 2) when it is initially connected to terrestrial network (TN).

A particular embodiment is characterized by wherein the user equipment (UE) is a user equipment for Narrowband Internet of things UE (NB-IoT), which considers utilizing the terrestrial network (TN) before upgrading to the higher-level Coverage Enhancement (CE, CE 1, CE 2) when it is initially connected to non terrestrial network to terrestrial network (NTN).

A certain embodiment is characterized by, when the User equipment (UE) reaches the maximum Random access (RA) procedure failure, the User equipment (UE) can consider switching to alternative network than upgrading the Coverage Enhancement (CE) level (k) by which the signaling overhead is and/or the power consumption of the user equipment UE is reduced.

A particular embodiment of the method for Energy Efficient Coverage Enhancement (CE) by a base station (gNB) in a wireless communication network, characterized by the steps: Receiving a random access (RA) request Coverage Enhancement (CE) a notification to a user equipment (UE) in idle mode state is send and user equipment (UE) decides whether to switch to alternative network or not based on overall network congestion,
whereby this decision information is determined by reaching the maximum of random access (RA) procedure failure for a Coverage Enhancement (CE) level (k),
in case the maximum of random access (RA) procedure failure for a Coverage Enhancement (CE) level (k) is reached,
a check if the user equipment (UE) triggered handover to alternative network should be proceeded is done,
if the result of the check is positive, then the handover to alternative network is proceeded,
if the result of the check is negative, then the user equipment (UE) stays in the same network and upgrades to Coverage Enhancement (CE) level (k) to the level (k+1) for random access (RA) procedure, whereby the base-station (gNB) configures whether user equipment (UE) is to switch to alternative network.

A certain embodiment the method for Energy Efficient Coverage Enhancement (CE) by a base station (gNB) in a wireless communication network, is characterized by steps: Receiving a random access (RA) request Coverage Enhancement (CE) a notification to a user equipment (UE) is in connected mode,
user equipment (UE) decides whether to switch to alternative network or not based on overall network congestion, whereby this decision information is determined by reaching the maximum of random access (RA) procedure failure for a Coverage Enhancement (CE) level (k), in case the maximum of random access (RA) procedure failure for a Coverage Enhancement (CE) level (k) is reached, a check if the user equipment (UE) triggered handover to alternative network should be proceeded is done, if the result of the check is positive, then the handover to alternative network is proceeded, if the result of the check is negative, then the user equipment (UE) stays in the same network and upgrades to Coverage Enhancement (CE) level (k) to the level (k+1) for random access (RA) procedure, whereby the base-station (gNB) configures whether user equipment (UE) is to switch to alternative network.

A certain embodiment of the method for Energy Efficient Coverage Enhancement (CE) by a base station (gNB) in a wireless communication network, is characterized by the steps:
Receiving a random access (RA) request Coverage Enhancement (CE) a notification to a user equipment (UE) is in connected mode,
user equipment (UE) decides whether to switch to alternative network or not based on overall network congestion, whereby this decision information is determined by reaching the maximum of random access (RA) procedure failure for a Coverage Enhancement (CE) level (k), in case the maximum of random access (RA) procedure failure for a Coverage Enhancement (CE) level (k) is reached, a check if the user equipment (UE) triggered handover to alternative network should be proceeded is done, if the result of the check is positive, then the handover to alternative network is proceeded, if the result of the check is negative, then the user equipment (UE) stays in the same network and upgrades to Coverage Enhancement (CE) level (k) to the level (k+1) for random access (RA) procedure, whereby the base-station (gNB) configures whether user equipment (UE) is to switch to alternative network.

A particular embodiment is characterized by an apparatus for receiving Transmission for Energy Efficient Coverage Enhancement (CE) from user equipment (UE) in a wireless communication network, the apparatus comprising a wireless transceiver, a processor coupled with a memory in which computer program instructions are stored, said instructions being configured to implement steps of the claims 1 to 7.

A particular embodiment is characterized by an apparatus for receiving Transmission for Energy Efficient Coverage Enhancement (CE) from a base station (gnB) in a wireless communication network, the apparatus comprising a wireless transceiver, a processor coupled with a memory (602) in which computer program instructions are stored, said instructions being configured to implement steps of the claims 8 to 9.

A certain embodiment is characterized by user equipment (UE) comprising an apparatus according to claim 10.

A particular embodiment is characterized by a base station comprising an apparatus according to claim 11.

A particular embodiment is characterized by wireless communication system for performing for Energy Efficient Coverage Enhancement from a base station to a user equipment, wherein the base station comprises a processor coupled with a memory in which computer program instructions are stored, said instructions being configured to implement steps of claims 8 to 9:
wherein the user equipment (UE) comprises a processor coupled with a memory in which computer program instructions are stored, said instructions being configured to implement steps of the claims 1 to 7.

A certain embodiment is characterized by a wireless communication system for performing for Energy Efficient Coverage Enhancement according to claim 14, whereby a user equipment (UE) triggered handover is performed after the user equipment (UE) takes a handover decision information based on a defined criteria from at least one cell A to at least another cell B, after the following steps are performed:
the user equipment (UE) sends a random access (RA) request Coverage Enhancement (CE) level (k) to a cell A,
cell A sends a random access (RA) failure Coverage Enhancement (CE) level (k) back to the user equipment (UE) and waits for user equipment (UE) to get connected with higher Coverage Enhancement (CE) level (k)
the user equipment (UE) sends a random access (RA) request Coverage Enhancement (CE) level (k) to a cell B, and if there is no random access (RA) possible for the user equipment (UE), Cell A buffers the data of the user equipment (UE).
cell B sends a random access (RA) response Coverage Enhancement (CE) level (k) back to the user equipment (UE) user equipment (UE) and cell B are connected
cell B updates user equipment (UE) details, if cell A gets an update from cell B regarding the user equipment (UE), cell A transfers the user equipment (UE) data to cell, if cell A gets no updates from other cells about the user equipment (UE) cell A declares radio link failure (RLF).

The information medium may be any entity or device capable of storing the program. For example, the medium can comprise a storage means, such as a ROM, for example a CD ROM or a microelectronic circuit ROM, FLASH memory or any magnetic recording means, for example a hard drive.

Moreover, the information medium may be a transmissible medium such as an electrical or optical signal, which may be conveyed via an electrical or optical cable, by radio or by other means.

Alternatively, the information medium may be an integrated circuit into which the program is incorporated, the circuit being adapted to execute or to be used in the execution of the methods in question.

The advantages of the apparatus, user equipment, wireless system, computer program and information medium are identical to those presented in relation with the corresponding method according to any one of the embodiments mentioned hereinabove.

### BRIEF DESCRIPTION OF THE DRAWINGS

Other advantages and characteristics of the invention will be more clearly apparent on reading the following description, given by way of simple illustrative and nonlimiting example, and the appended drawings, among which:

FIG. 1 shows the coverage enhancement (CE).

FIG. 2a shows a successful RA.

FIG. 2b shows Random Access (RA) failure and retransmission.

FIG. 3 shows the repetition of preamble (CE).

FIG. 4 shows the flow chart of a State of the Art coverage enhancement (CE) procedure.

FIG. 5 shows the flow chart of the first embodiment on UE-side.

FIG. 6 shows the flow chart of the first embodiment on gNB-side.

FIG. 7 shows the flow chart of the second embodiment on UE-side.

FIG. 8 shows the flow chart of the second embodiment on gNB-side.

FIG. 9 shows UE triggered handover.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise.

The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

Narrowband Internet of things (NB-IoT) is a low-power wide-area network (LPWAN) radio technology standard developed by 3GPP for cellular devices and services. The specification was frozen in 3GPP Release 13 (LTE Advanced Pro), in June 2016. Other 3GPP IoT technologies include eMTC (enhanced Machine-Type Communication) and EC-GSM-IoT. NB-IoT focuses specifically on indoor coverage, low cost, long battery life, and high connection density. NB-IoT uses a subset of the LTE standard, but limits the bandwidth to a single narrow-band of 200 kHz. It uses OFDM modulation for downlink communication and SC-FDMA for uplink communications. IoT applications which require more frequent communications will be better served by NB-IoT, which has no duty cycle limitations operating on the licensed spectrum.

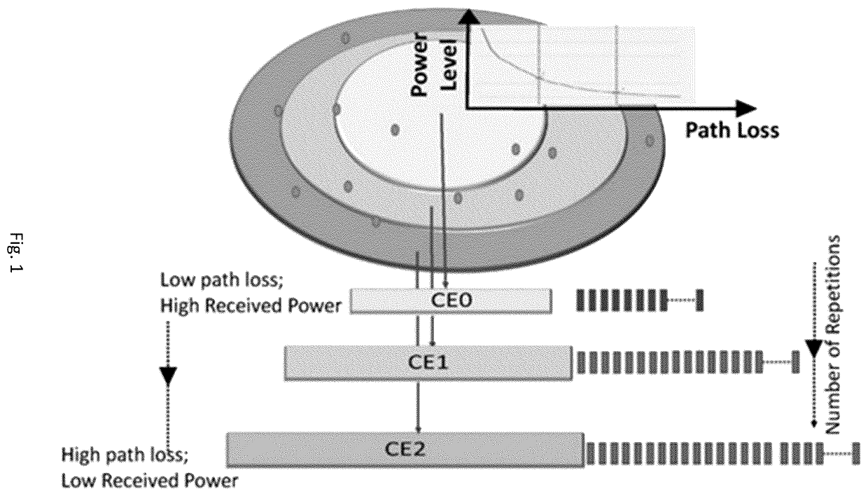

FIG. 1 shows the coverage enhancement. Coverage Enhancement is to provide reliable connections with extended coverage, a retransmission, repetition, and power ramping schemes and CE groups are introduced into NB-IoT during both RACH procedure and data transmission procedure. Retransmission means repetition of RA request in case of no RA response. Repetition means repetition of preambles to improve the probability of detection at gNB. Power ramping means increase transmit power level to compensate higher path loss.

FIG. 1 illustrates coverage enhancement for NTNs in accordance with aspects of the present disclosure. The wireless communications system may include one or more base stations, one or more UEs, and a core network. In some examples, the wireless communications system may be a Long Term Evolution (LTE) network, an LTE-Advanced (LTE-A) network, an LTE-A Pro network, or a New Radio (NR) network. In some examples, the wireless communications system may support enhanced broadband communications, ultra-reliable (e.g., mission critical) communications, low latency communications, communications with low-cost and low-complexity devices, or any combination thereof.

The base stations may be dispersed throughout a geographic area to form the wireless communications system and may be devices in different forms or having different capabilities. The base stations and the UEs may wirelessly communicate via one or more communication links. Each base station may provide a coverage area over which the UEs and the base station may establish one or more communication links. The coverage area may be an example of a geographic area over which a base station and a UE may support the communication of signals according to one or more radio access technologies.

The UEs may be dispersed throughout a coverage area of the wireless communications system, and each UE may be stationary, or mobile, or both at different times. The UEs may be devices in different forms or having different capabilities. The UEs described herein may be able to communicate with various types of devices, such as other UEs, the base stations, or network equipment (e.g., core network nodes, relay devices, integrated access and backhaul (IAB) nodes, or other network equipment).

The base stations may communicate with the core network, or with one another, or both. For example, the base stations may interface with the core network through one or more backhaul links (e.g., via an S1, N2, N3, or other interface). The base stations may communicate with one another over the backhaul links (e.g., via an X2, Xn, or other interface) either directly (e.g., directly between base stations), or indirectly (e.g., via core network), or both. In some examples, the backhaul links may be or include one or more wireless links.

One or more of the base stations described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE may include or may be referred to as a mobile device, a wireless device, a remote device, a handheld device, or a subscriber device, or some other suitable terminology, where the “device” may also be referred to as a unit, a station, a terminal, or a client, among other examples. A UE may also include or may be referred to as a personal electronic device such as a cellular phone, a personal digital assistant (PDA), a tablet computer, a laptop computer, or a personal computer. In some examples, a UE may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs described herein may be able to communicate with various types of devices, such as other UEs that may sometimes act as relays as well as the base stations and the network equipment including macro eNBs or gNBs, small cell eNBs or gNBs, or relay base stations, among other examples, as shown in FIG. 1.

The UEs and the base stations may wirelessly communicate with one another via one or more communication links over one or more carriers. The term “carrier” may refer to a set of radio frequency spectrum resources having a defined physical layer structure for supporting the communication links. For example, a carrier used for a communication link may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system may support communication with a UE using carrier aggregation or multi-carrier operation. A UE may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE receives and the higher the order of the modulation scheme, the higher the data rate may be for the UE. A wireless communications resource may refer to a combination of a radio frequency spectrum resource, a time resource, and a spatial resource (e.g., spatial layers or beams), and the use of multiple spatial layers may further increase the data rate or data integrity for communications with a UE.

The time intervals for the base stations or the UEs may be expressed in multiples of a basic time unit which may, for example, refer to a sampling period of Ts=1/(Δfmax·Nf) seconds, where Δfmax may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots.

Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs. For example, one or more of the UEs may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs and UE-specific search space sets for sending control information to a specific UE.

In some examples, a base station may be movable and therefore provide communication coverage for a moving geographic coverage area. In some examples, different geographic coverage areas associated with different technologies may overlap, but the different geographic coverage areas may be supported by the same base station. In other examples, the overlapping geographic coverage areas associated with different technologies may be supported by different base stations. The wireless communications system may include, for example, a heterogeneous network in which different types of the base stations provide coverage for various geographic coverage areas using the same or different radio access technologies.

The wireless communications system may be configured to support ultra-reliable communications or low-latency communications, or various combinations thereof. For example, the wireless communications system may be configured to support ultra-reliable low-latency communications (URLLC) or mission critical communications. The UEs may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE may also be able to communicate directly with other UEs over a device-to-device (D2D) communication link (e.g., using a peer-to-peer (P2P) or D2D protocol). One or more UEs utilizing D2D communications may be within the geographic coverage area of a base station. Other UEs in such a group may be outside the geographic coverage area of a base station or be otherwise unable to receive transmissions from a base station. In some examples, groups of the UEs communicating via D2D communications may utilize a one-to-many (1: M) system in which each UE transmits to every other UE in the group. In some examples, a base station facilitates the scheduling of resources for D2D communications. In other cases, D2D communications are carried out between the UEs without the involvement of a base station.

The core network may provide user authentication, access authorization, tracking, Internet Protocol (IP) connectivity, and other access, routing, or mobility functions. The core network may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs served by the base stations associated with the core network. User IP packets may be transferred through the user plane entity, which may provide IP address allocation as well as other functions. The user plane entity may be connected to the network operators IP services. The operators IP services may include access to the Internet, Intranet(s), an IP Multimedia Subsystem (IMS), or a Packet-Switched Streaming Service.

Some of the network devices, such as a base station, may include subcomponents such as an access network entity, which may be an example of an access node controller (ANC). Each access network entity may communicate with the UEs through one or more other access network transmission entities, which may be referred to as radio heads, smart radio heads, or transmission/reception points (TRPs). Each access network transmission entity may include one or more antenna panels. In some configurations, various functions of each access network entity or base station may be distributed across various network devices (e.g., radio heads and ANCs) or consolidated into a single network device (e.g., a base station).

The wireless communications system may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system may utilize both licensed and unlicensed radio frequency spectrum bands. For example, the wireless communications system may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations and the UEs may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station or a UE may be equipped with multiple antennas, which may be used to employ techniques such as transmit diversity, receive diversity, multiple-input multiple-output (MIMO) communications, or beamforming. The antennas of a base station or a UE may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station may be located in diverse geographic locations. A base station may have an antenna array with a number of rows and columns of antenna ports that the base station may use to support beamforming of communications with a UE. Likewise, a UE may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station, a UE) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference.

The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system includes base stations, UEs, satellites, and a core network. In some examples, the wireless communications system may be an LTE network, an LTE-A network, an LTE-A Pro network, or a NR network. In some cases, wireless communications system may support enhanced broadband communications, ultra-reliable (e.g., mission critical) communications, low latency communications, or communications with low-cost and low-complexity devices.

Wireless communications system may also include one or more satellites. Satellite may communicate with base stations (also referred to as gateways in NTNs) and UEs (or other high altitude or terrestrial communications devices). Satellite may be any suitable type of communication satellite configured to relay communications between different end nodes in a wireless communication system. Satellite may be an example of a space satellite, a balloon, a dirigible, an airplane, a drone, an unmanned aerial vehicle, and/or the like. In some examples, the satellite may be in a geosynchronous or geostationary earth orbit, a low earth orbit or a medium earth orbit. A satellite may be a multi-beam satellite configured to provide service for multiple service beam coverage areas in a predefined geographical service area. The satellite may be any distance away from the surface of the earth.

In some cases, a cell may be provided or established by a satellite as part of a non-terrestrial network. A satellite may, in some cases, perform the functions of a base station, act as a bent-pipe satellite, or may act as a regenerative satellite, or a combination thereof. In other cases, satellite may be an example of a smart satellite, or a satellite with intelligence. For example, a smart satellite may be configured to perform more functions than a regenerative satellite (e.g., may be configured to perform particular algorithms beyond those used in regenerative satellites, to be reprogrammed, etc.). A bent-pipe transponder or satellite may be configured to receive signals from ground stations and transmit those signals to different ground stations. In some cases, a bent-pipe transponder or satellite may amplify signals or shift from uplink frequencies to downlink frequencies. A regenerative transponder or satellite may be configured to relay signals like the bent-pipe transponder or satellite, but may also use on-board processing to perform other functions. Examples of these other functions may include demodulating a received signal, decoding a received signal, re-encoding a signal to be transmitted, or modulating the signal to be transmitted, or a combination thereof. For example, a bent-pipe satellite (e.g., satellite) may receive a signal from a base station and may relay the signal to a UE or base station, or vice-versa. In accordance with various aspects of the present disclosure, coverage enhancement for communications with satellites 120 may be provided through repetitions of communications, which may reduce BLER and enhance communications reliability.

A UE may include a UE communications manager. The UE communications manager may receive from a base station or a satellite, an indication of a repetition activation for communications. The UE communications manager may determine, responsive to the repetition indication, resources for communications that contain repetitions. When receiving communications, the UE communications manager may buffer signals from resources containing multiple transmissions, and attempt to decode the associated communication. In some cases, when transmitting an uplink message to the base station or the satellite, the UE communications manager may prepare multiple repetitions of the communication based on the configured repetitions. Further, in some cases, uplink messages may be transmitted using a smaller frequency bandwidth than a full channel bandwidth, in order to provide a higher power density and enhance the likelihood of reception of the uplink message.

A base station may include a base station communications manager. The base station communications manager may configure a coverage enhancement scheme at one or more UEs in which a number of repetitions of communications are provided to help reduce BLER. Repetitions may be provided through slot bundling for PDCCH in consecutive or non-consecutive slots, or through multiple repetitions within the same slot.

Coverage Enhancement: CE is achieved through repetition in time, retransmission, and power-boosting in-band and guard band operating modes. The coverage extension feature of NB-IoT is handy when the sensors are located in remote or challenging areas. Reliable coverage enhancement is achieved by the repeated transmission of data and control signaling. Each transmission can be configured to repeat for a designated number of times in order to achieve higher success opportunities at the desired coverage level.

Number of repetition value is directly proportional to Maximum Coupling Loss (MCL).

Number of repetitions will improve the SNR at the receiver. Increase in number of repetitions results in increase in energy consumption. Large repetition number results in higher latency. CE will result in radio resource wastage (UE occupies a channel for longer duration in case of higher-level CE). CE is suitable for latency insensitive applications (applications that can tolerate 10 seconds of transmission delay). Avoiding CE upgradation with any alternative can improve energy efficiency and reduce radio resource wastage.

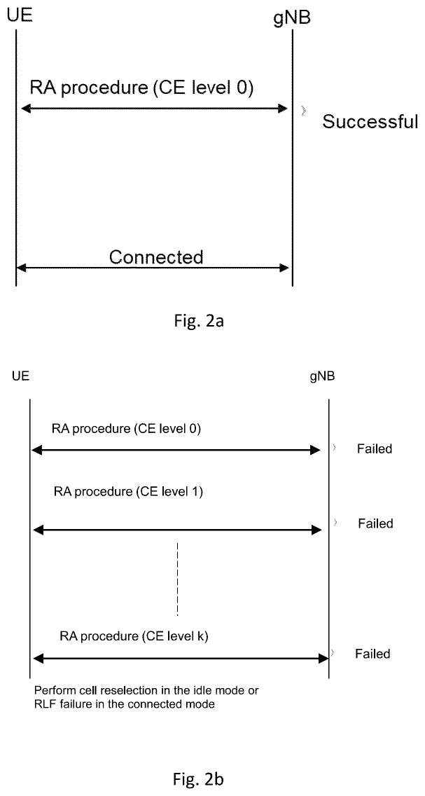

FIG. 2 shows the establishment of a successful RA.

FIG. 2 b shows RA failure and retransmission.

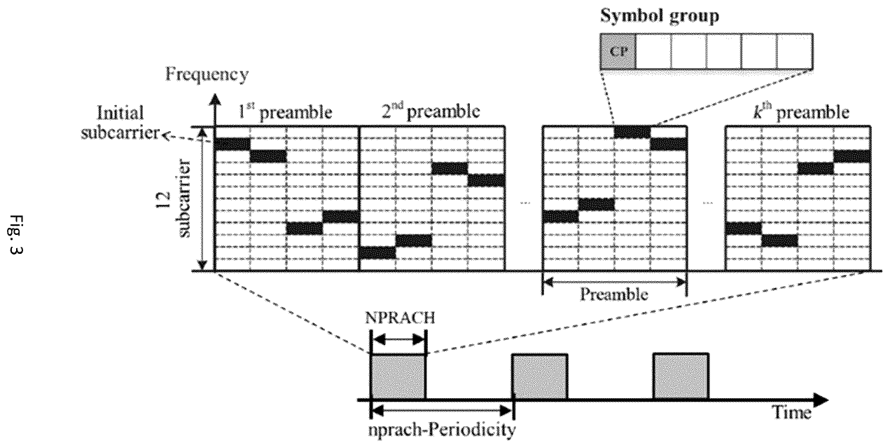

FIG. 3 shows the repetition of preamble (CE).

In this FIGS. 2a, 2b and 3 UE behavior is if all the RA attempts are failed, then UE will perform cell reselection in idle mode or report RLF in connected mode.

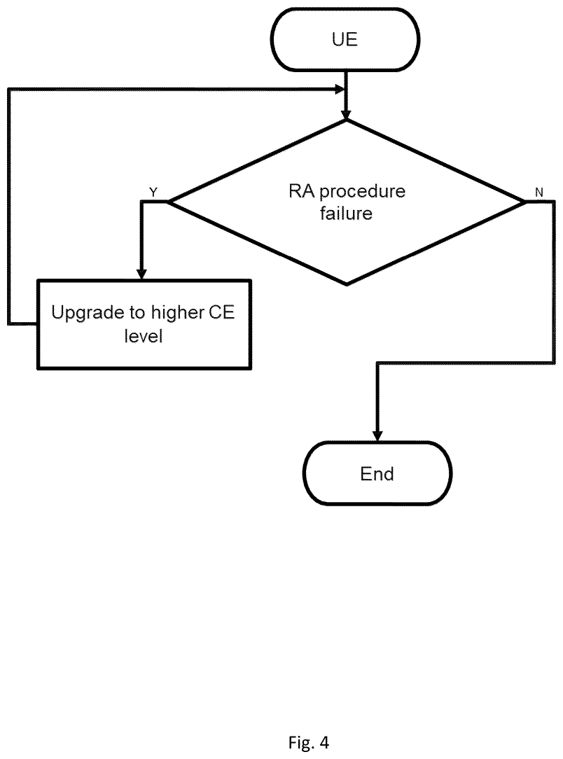

FIG. 4 shows the flow chart of a State of the Art CE procedure.

User equipment (UE) tries to proceed the random access (RA). In case of generating the failure and upgrade to a higher CE level are proceeded. If there is no regular radio access (RA) procedure failure given any more the flow stops.

The core aspect of this new method is to create a mechanism where UE take decision, whether to upgrade to higher level of CE or to switch the network (TN to NTN or NTN to TN) in case of reaching maximum RA procedure failure. UE (NB-IoT) can consider utilizing the NTN before upgrading to the higher-level CE (CE 1, CE 2) when it is initially connected to TN. UE (NB-IoT) can consider utilizing the TN before upgrading to the higher-level CE (CE 1, CE 2) when it is initially connected to NTN.

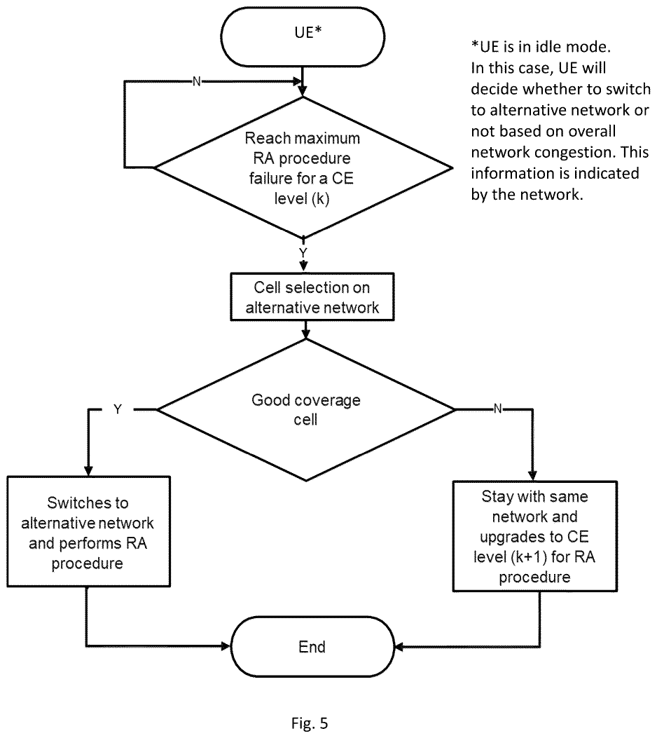

FIG. 5 shows the flow chart of the first embodiment on UE-side. Method for Energy Efficient Coverage Enhancement (CE) by a user equipment (UE) device is connected to a wireless communication network, wherein the user equipment (UE) decides to upgrade to higher level of Coverage Enhancement (CE) or to switch the network in case of reaching maximum Random Access (RA) procedure failure. User equipment (UE) is in idle mode, user equipment (UE) decides whether to switch to alternative network or not based on overall network congestion, whereby this information is indicated by the network, by reaching the maximum of random access (RA) procedure failure for a Coverage Enhancement (CE) level (k), cell selection on alternative networks is proceed, the coverage of the cell is verified and in case of the coverage of the cell is sufficient, then the user equipment (UE) is switched to alternative network and performs random access (RA) procedure, in case of the coverage of the cell is insufficient, then the user equipment (UE) stays in the same network and upgrades to Coverage Enhancement (CE) level (k) to the level (k+1) for random access (RA) procedure.

UE switches to alternative network, only when there is a good coverage in the alternative network. If not, UE will stay with the same network and upgrade the CE level.

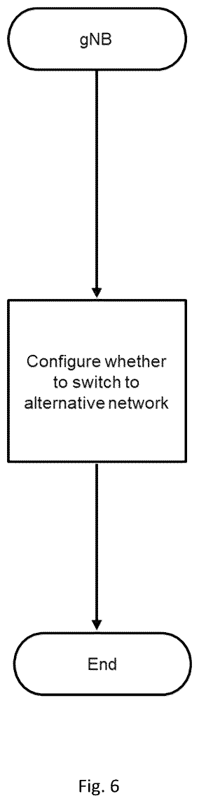

FIG. 6 shows the flow chart of the first embodiment on base-station (gNB) side.

The method comprises receiving a random access (RA) request Coverage Enhancement (CE) a notification to a user equipment (UE) in idle mode state is send and user equipment (UE) decides whether to switch to alternative network or not based on overall network congestion, whereby this decision information is determined by reaching the maximum of random access (RA) procedure failure for a Coverage Enhancement (CE) level (k), in case the maximum of random access (RA) procedure failure for a Coverage Enhancement (CE) level (k) is reached, a check if the user equipment (UE) triggered handover to alternative network should be proceeded is done, if the result of the check is positive, then the handover to alternative network is proceeded, if the result of the check is negative, then the user equipment (UE) stays in the same network and upgrades to Coverage Enhancement (CE) level (k) to the level (k+1) for random access (RA) procedure, whereby the base-station (gNB) configures whether user equipment (UE) is to switch to alternative network.

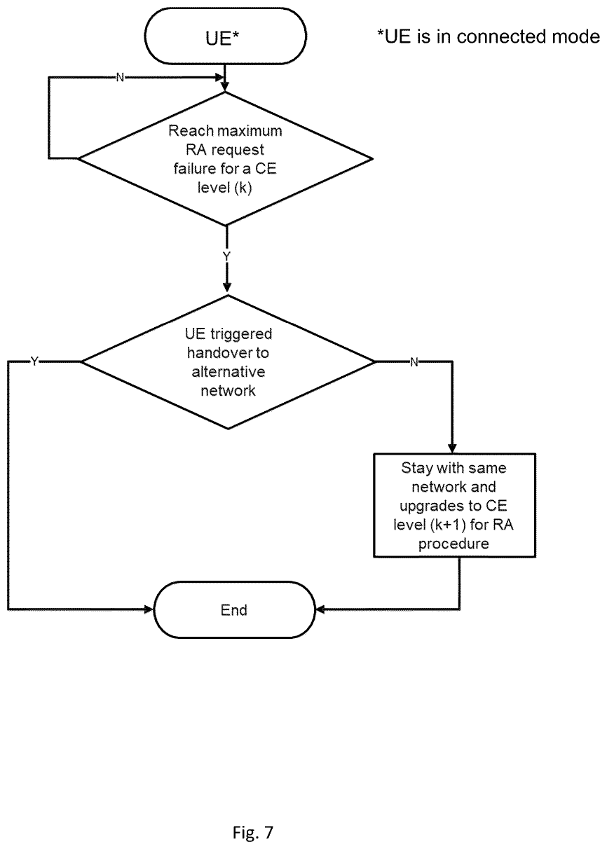

FIG. 7 shows the flow chart of the second embodiment on UE-side. This embodiment comprises the steps that user equipment (UE) is in connected mode, user equipment (UE) decides whether to switch to alternative network or not based on overall network congestion, whereby this decision information is determined by reaching the maximum of random access (RA) procedure failure for a Coverage Enhancement (CE) level (k), in case the maximum of random access (RA) procedure failure for a Coverage Enhancement (CE) level (k) is reached, a check if the user equipment (UE) triggered handover to alternative network should be proceeded is done, if the result of the check is positive, then the handover to alternative network is proceeded, if the result of the check is negative, then the user equipment (UE) stays in the same network and upgrades to Coverage Enhancement (CE) level (k) to the level (k+1) for random access (RA) procedure.

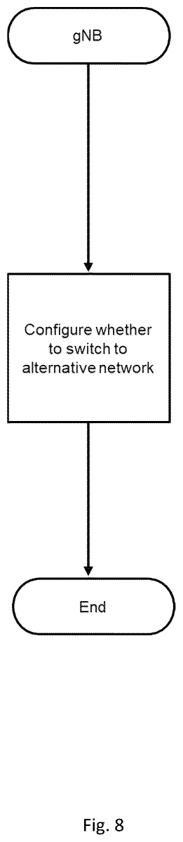

FIG. 8 shows the flow chart of the second embodiment on gNB-side.

The method comprises the steps: Receiving a radio access (RA) request Coverage Enhancement (CE) a notification to a user equipment (UE) is in connected mode,
user equipment (UE) decides whether to switch to alternative network or not based on overall network congestion, whereby this decision information is determined by reaching the maximum of random access (RA) procedure failure for a Coverage Enhancement (CE) level (k), in case the maximum of random access (RA) procedure failure for a Coverage Enhancement (CE) level (k) is reached, a check if the user equipment (UE) triggered handover to alternative network should be proceeded is done. If the result of the check is positive, then the handover to alternative network is proceeded, if the result of the check is negative, then the user equipment (UE) stays in the same network and upgrades to Coverage Enhancement (CE) level (k) to the level (k+1) for random access (RA) procedure, whereby the base-station (gNB) configures whether user equipment (UE) is to switch to alternative network.

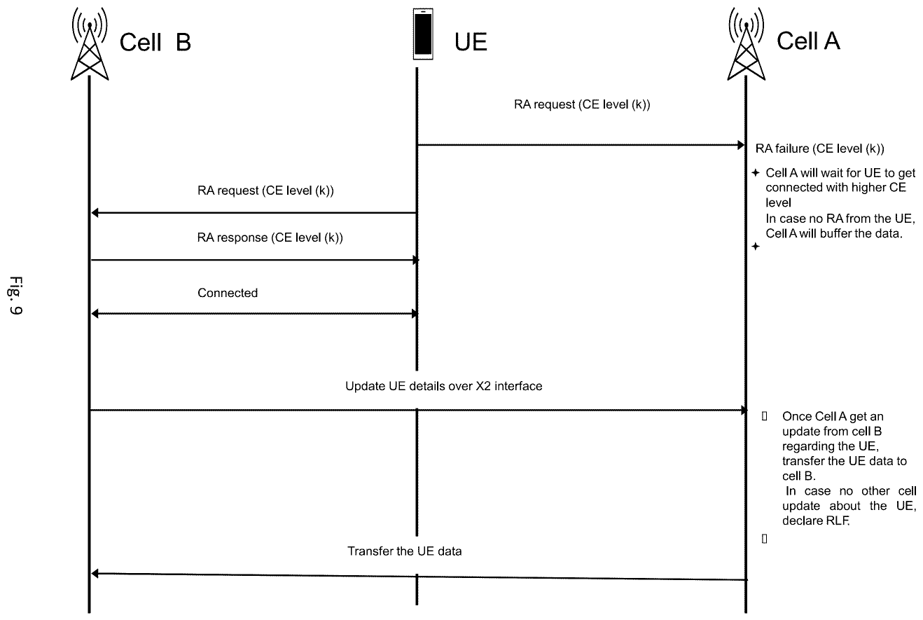

FIG. 9 shows UE triggered handover. Wireless communication system for performing for Energy Efficient Coverage Enhancement, whereby a user equipment (UE) triggered handover is performed after the user equipment (UE) takes a handover decision information based on a defined criteria from at least one cell A to at least another cell B, after the following steps are performed:
The user equipment (UE) sends a random access (RA) request Coverage Enhancement (CE) level (k) to a cell A,
Cell A sends a random access (RA) failure Coverage Enhancement (CE) level (k) back to the user equipment (UE) and waits for user equipment (UE) to get connected with higher Coverage Enhancement (CE) level (k).

The user equipment (UE) sends a random access (RA) request Coverage Enhancement (CE) level (k) to a cell B, and if there is no random access (RA) possible for the user equipment (UE), Cell A buffers the data of the user equipment (UE).

Cell B sends a random access (RA) response Coverage Enhancement (CE) level (k) back to the user equipment (UE). User equipment (UE) and cell B are connected.

Cell B updates user equipment (UE) details, if cell A gets an update from cell B regarding the user equipment (UE), cell A transfers the user equipment (UE) data to cell, if cell A gets no updates from other cells about the user equipment (UE) cell A declares radio link failure (RLF).

Advantages of this new approaches are low power consumption. NB-IoT & LTE-M chipsets focus on the wireless characteristics that applications require and have power-saving features such as sleep mode, long-periodic tracking area updates and extended discontinuous reception, which ensures optimal energy efficiency.

Furthermore deep building penetration is possible. NB-IoT and LTE-M have up to 20 decibels (NB-IoT) and 15 decibels (LTE-M) higher power density compared to GSM to narrowband modulation and multiple transmission repetitions. This ensures better network coverage inside buildings.

A very important aspect of this new approach are the low costs. Both LTE-M and NB-IoT score with low module costs as well as low operating and service prices. This is ensured by the simple chipset design, which dispenses with unnecessary LTE functions, as well as increasing production volumes.

All described solutions are LTE-based. NB-IoT and LTE-M are based on LTE and can be integrated into existing LTE infrastructures via software upgrade. Since both NB-IoT and LTE-M can be provided in the GSM and LTE spectrum, no additional spectrum licenses are required.

Unlike sensors that cannot transmit over long distances, both NB-IoT and LTE-M work via plug & play. Sensors are directly connected to the NB-IoT and/or LTE-M networks without the need to install local networks or gateways.

A further very relevant aspect of the described solutions is that they are extremely secure. NB-IoT and LTE-M are globally standardized technologies and use LTE security mechanisms according to 3GPP.

Abbreviations:

| | |
|---|---|
| Discontinuous Reception | DRX |
| Extended Discontinuous | eDRX |
| Reception gNB: gNodeB | |
| Internet of Things | IoT |
| Low Power Wide Area Network | LPWAN |
| Narrow Band Internet of Things | NB-IoT |
| Release Assistance Indicator | RAI |
| Random Access | RA |
| Random Access Channel | RACH |
| User Equipment | UE |
| Wake Up Signal | WuS |

1. A method for Energy Efficient Coverage Enhancement by a user equipment device connected to a wireless communication network, wherein the user equipment decides to upgrade to higher level of Coverage Enhancement or to switch the network in case of reaching maximum Random access procedure failure.

2. The method for Energy Efficient Coverage Enhancement according to claim 1, comprising the steps that the user equipment follows when it is in idle mode, user equipment decides whether to switch to an alternative network or not, based on overall network congestion, whereby this information is indicated by the network, by reaching the maximum of random access procedure failure for a Coverage Enhancement level, then the user equipment proceeds with cell selection on alternative networks, whereby the coverage of the cell is verified and in case the coverage of the cell is sufficient, the user equipment switches to the alternative network and performs random access procedure, in case the coverage of the cell is insufficient, the user equipment stays in the same network and upgrades to Coverage Enhancement) level from the level for random access procedure.

3. The method for Energy Efficient Coverage Enhancement according to claim 1, comprising the steps that user equipment follows when it is in connected mode user equipment decides whether to switch to alternative network or not based on overall network congestion, whereby this decision information is determined by reaching the maximum of random access procedure failure for a Coverage Enhancement level, in case the maximum of random access procedure failure for a Coverage Enhancement level is reached, a check if the user equipment triggered handover to alternative network should be proceeded is done, if the result of the check is positive, then the handover to alternative network is proceeded, if the result of the check is negative, the user equipment stays in the same network and upgrades to Coverage Enhancement level from the level for random access procedure.

4. The method for Energy Efficient Coverage Enhancement according to claim 1, wherein in case of reaching maximum Random access procedure failure the network is switched from terrestrial network to non terrestrial network or from non terrestrial network to terrestrial network.

5. The method according to claim 1, wherein the user equipment is a user equipment for Narrowband Internet of things UE, which considers utilizing the non terrestrial network-ANTA to terrestrial network before upgrading to the higher-level Coverage Enhancement when it is initially connected to terrestrial network.

6. The method according to claim 1 wherein the user equipment is a user equipment for Narrowband Internet of things UE, which considers utilizing the terrestrial network before upgrading to the higher-level Coverage Enhancement when it is initially connected to non terrestrial network to terrestrial network.

7. The method according to claim 1, wherein the method is characterized by when the User equipment reaches the maximum Random access procedure failure, the User equipment has an opportunity to switch the network rather than upgrading the Coverage Enhancement level by which the signaling overhead and/or the power consumption of the user equipment UE is reduced.

8. A method for Energy Efficient Coverage Enhancement by a base station in a wireless communication network, wherein the method comprises:
Receiving a random access request Coverage Enhancement a notification to a user equipment in idle mode state is sent and
user equipment decides whether to switch to alternative network or not based on overall network congestion,
whereby this decision information is determined by reaching the maximum of random access procedure failure for a Coverage Enhancement level,
in case the maximum of random access procedure failure for a Coverage Enhancement level is reached,
a check if the user equipment triggered handover to alternative network should be proceeded is done,
if the result of the check is positive, then the handover to alternative network is proceeded, if the result of the check is negative, then the user equipment stays in the same network and upgrades to Coverage Enhancement level from the current level for random access procedure, whereby the base-station configures whether user equipment is to switch to alternative network.

9. A method for Energy Efficient Coverage Enhancement by a base station in a wireless communication network, wherein the method comprises:
Receiving a random access request Coverage Enhancement a notification to a user equipment is in connected mode,
user equipment decides whether to switch to alternative network or not based on overall network congestion, whereby this decision information is determined by reaching the maximum of random access procedure failure for a Coverage Enhancement level, in case the maximum of random access procedure failure for a Coverage Enhancement level is reached, a check if the user equipment triggered handover to alternative network should be proceeded is done, if the result of the check is positive, then the handover to alternative network is proceeded, if the result of the check is negative, then the user equipment stays in the same network and upgrades to Coverage Enhancement level from the current level for random access procedure, whereby the base-station configures whether user equipment is to switch to alternative network.

10. An apparatus for receiving Transmission for Energy Efficient Coverage Enhancement from user equipment in a wireless communication network, the apparatus comprising a wireless transceiver, a processor coupled with a non-transitory memory in which computer-executable instructions are stored, said instructions being configured to perform operations comprising: deciding by the user equipment, to upgrade to higher level of Coverage Enhancement or to switch the network in case of reaching maximum Random access procedure failure.

11. An apparatus for receiving Transmission for Energy Efficient Coverage Enhancement from a base station in a wireless communication network, the apparatus comprising a wireless transceiver, a processor coupled with a non-transitory memory in which computer-executable instructions are stored, said instructions being configured to perform operations comprising:
Receiving a random access request Coverage Enhancement a notification to a user equipment in idle mode state is sent and
user equipment decides whether to switch to alternative network or not based on overall network congestion,
whereby this decision information is determined by reaching the maximum of random access procedure failure for a Coverage Enhancement level,
in case the maximum of random access procedure failure for a Coverage Enhancement level is reached,
a check if the user equipment triggered handover to alternative network should be proceeded is done,
if the result of the check is positive, then the handover to alternative network is proceeded, if the result of the check is negative, then the user equipment stays in the same network and upgrades to Coverage Enhancement level from the current level for random access procedure whereby the base station configures whether user equipment is to switch to alternative network.

12. The apparatus according to claim 10, wherein the apparatus is a User Equipment.

13. The apparatus according to claim 11, wherein the apparatus is a base station.

14. (canceled)

15. (canceled)
